(19) United States
(12) Patent Application Publication
(10) Pub. No.: US 2004/0057734 A1
(43) Pub. Date: Mar. 25, 2004

(54) Method and system for reducing transmission penalties associated with ghost pulses

(75) Inventor: Taras Igorevich Lakoba, Winter Park, FL (US)

Correspondence Address: MOSER, PATTERSON & SHERIDAN L.L.P., 595 SHREWSBURY AVE, FIRST FLOOR, SHREWSBURY, NJ, 07702, US

(73) Assignee: LUCENT TECHNOLOGIES, INC.

(21) Appl. No.: 10/254,132

(22) Filed: Sep. 25, 2002

(51) Int. Cl. H04J 14/02; H04B 10/04

(52) U.S. Cl. 398/192; 398/193; 398/183; 398/158; 398/81

(57) ABSTRACT

A method and apparatus for reducing transmission penalties associated with ghost pulses in an optical signal in a transmission system includes providing phase modulation to the optical signal in the transmission system with a period of phase modulation greater than a bit period of the transmission system, wherein the phase modulation is applied to the optical signal such that the phases of at least some logical “ones” within a sequence of logical “ones” of the optical signal are modified such that the phases of the individual ghost-pulse fields from each triplet of “ones” are different, either pseudo-randomized or substantially shifted by π, thereby resulting in a reduction of the total ghost pulse. Advantageously, there is no need to synchronize the timing of the phase modulation with the timing of the power profile of the optical signal.

### FIELD OF THE INVENTION

This invention relates to the field of optical transmission systems and, more specifically, to reducing transmission penalties in optical transmission systems.

### BACKGROUND OF THE INVENTION

WDM transmission at 40 Gbit/s and above through fiber with relatively high dispersion tends to be limited by nonlinear interactions occurring within each individual channel. The limitations caused by nonlinear transmission take several forms including cross-phase modulation (XPM) and intra-channel four-wave mixing (IFWM).

One specific transmission penalty produced by IFWM that can drastically limit transmission in high-bit-rate systems, particularly for standard single-mode fibers (SSMF), is the generation of “ghost pulses” (shadow pulses). Ghost pulses (GPs) are created when, due to fiber dispersion, pulses propagating in the fiber spread out and overlap with each other. The overlap, along with fiber nonlinearity, cause creation of small parasitic pulses, known as ghost pulses, proximate the “zero” pulses in a sequence of pulses representing logical “ones” and “zeros.” If the GPs grow to be large they can be detected by a receiver as logical “ones,” which can lead to transmission errors.

### SUMMARY OF THE INVENTION

The present invention advantageously provides a method for reducing transmission penalties associated with GPs. Suppression of the generation of GPs in accordance with the present invention will achieve non-regenerated transmission over longer distances than would otherwise be possible. The present invention determines specific parameters of the phase modulation for which the relative timing between the phase modulation applied to the signal and the signal's power profile is arbitrary.

In one embodiment of the present invention, a method for reducing transmission penalties associated with ghost pulses in an optical signal in a transmission system includes providing phase modulation to the optical signal at, or immediately following, the transmitter to modify the phases of all of the logical “ones” of the optical signal, such that the phases of each individual ghost-pulse field created by an individual triplet of “ones” become substantially different, and the resulting total ghost pulse, which is a sum of the individual ghost-pulse fields, is reduced compared to the case where no phase modulation is applied.

In another embodiment of the present invention, a method for reducing transmission penalties associated with ghost pulses in an optical signal in a transmission system includes providing phase modulation to the optical signal near the midpoint of the optical transmission system with a period of phase modulation greater than a bit period of the optical transmission system, wherein the phases of at least some logical “ones” within a sequence of logical “ones” of the optical signal are modified such that their combined phases result in a reduction of the total ghost pulses.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a transmission system including a first embodiment of the present invention;

FIG. 2a graphically depicts the optical signal-to-noise ratio (OSNR) required for a bit error rate (BER) of 10⁻⁹ in the transmission system of FIG. 1 for the case of no phase modulation and single standard mode fiber;

FIG. 2b graphically depicts the corresponding optical eye diagram for the section of the bit sequence depicted in FIG. 2a for the case of optimal dispersion post-compensation;

FIGS. 3a-3d graphically depict the required OSNR for a BER of 10⁻⁹ for the transmission system of FIG. 1, for a specific phase modulation amplitude and varied phase modulation periods;

FIGS. 3e-3h graphically depict the required OSNR for a BER of 10⁻⁹ for the transmission system of FIG. 1, for a different phase modulation amplitude than in FIGS. 3a-3d and for the same varied phase modulation periods;

FIG. 4 graphically depicts an optical eye diagram for an optical signal at the output of the transmission system for the worst-case scenario depicted in FIG. 3g;

FIG. 5a graphically depicts the OSNR required for a BER of 10⁻⁹ for 16 spans of 100 km of TWRS™ fiber and no phase modulation;

FIG. 5b graphically depicts the corresponding optical eye diagram for the section of the bit sequence depicted in FIG. 5a for the case of optimal dispersion post-compensation;

FIGS. 6a-6c graphically depict the required OSNR for a BER of 10⁻⁹ for the transmission system of FIG. 5a, for a specific phase modulation amplitude and varied phase modulation periods;

FIGS. 6d-6f graphically depict the required OSNR for a BER of 10⁻⁹ for the transmission system of FIG. 5a, for a different phase modulation amplitude than in FIGS. 6a-6c and for the same varied phase modulation periods;

FIG. 7 graphically depicts an optical eye diagram for a section of the bit sequence in the transmission system of FIG. 5a;

FIG. 8 depicts a high-level block diagram of a transmission system including a second embodiment of the present invention;

FIG. 9 graphically depicts the OSNR required for a BER of 10⁻⁵ in the transmission system of FIG. 8 for the case of no phase modulation, and for the cases wherein the phase modulation has a specific amplitude, a specific period, and varying values of a constant, characterizing the phase of the RF phase-modulating signal;

FIG. 10a graphically depicts an electrical eye diagram and an optical waveform diagram for the section of the bit sequence depicted in FIG. 9 with no phase modulation; and

FIG. 10b graphically depicts an electrical eye diagram and an optical waveform diagram for the section of the bit sequence depicted in FIG. 9 for the best case of phase modulation applied after the 6^{th} span.

To facilitate understanding, identical reference numerals have been used, where possible, to designate identical elements that are common to the figures.

### DETAILED DESCRIPTION OF THE INVENTION

The present invention advantageously provides a method and apparatus for reducing transmission penalties associated with “ghost pulses” (GPs). Suppression of the generation of ghost pulses in accordance with the present invention enables non-regenerated optical transmission over longer distances than would otherwise be possible. Although the present invention will be described within the context of a transmission line utilizing standard single-mode fiber (SSMF) and carrier-suppressed return-to-zero (CSRZ) pulses, it will be appreciated by those skilled in the art that the method of the present invention can be advantageously implemented in any transmission system in which ghost pulses are created by nonlinear pulse-to-pulse interaction. In particular modifications that are required for suppression of GPs in non-zero dispersion-shifted fibers (NZ DSF), such as TrueWave Reduced Slope (TWRS™) fiber, will be described.

It is important to note that the present invention determines specific parameters of the phase modulation, for which the relative timing between the phase modulation applied to the signal and the signal's power profile is arbitrary. Such arbitrary timing eliminates the need to provide synchronization between the phase modulation circuitry and the circuitry generating optical signals. In this manner, implementing the techniques of the invention are easier and cheaper than in cases wherein synchronization is necessary. Moreover the application of phase modulation to all channels at once rather than on a per-channel basis can now be realized.

GPs are generated by intra-channel four-wave mixing (IFWM), which is one of the two main nonlinear impairments in high-bit-rate systems. The other impairment is cross-phase modulation (XPM). IFWM is a coherent effect, whereby electric fields of three logical “ones” overlap (due to the pulses' dispersive broadening) and create, through nonlinear response of the fiber, a small pulse-like field (i.e., a ghost pulse) at a specific location of their overlap. By “coherent,” it is meant that the phase of that ghost pulse depends on a combination of the phases of the “ones” which have created it. Furthermore, it can be shown that the location of the IFWM-generated field created coincides with a middle of a bit slot in the sequence of pulses. If the slot is a 0, a GP is generated. If the GPs grow to be large, they can be detected by a receiver as logical “ones”, which can lead to transmission errors. In the case of bit slots with a 1, the interference between the 1 bit and the IFWM-generated field leads to amplitude jitter.

In considering an exemplary long sequence of “ones” and “zeros”, e.g., 1111101111, it is clear that there are several triplets of “ones” that can create a GP at the location of the “zero”. If the phases of the “ones” are different, the phases of the corresponding GP fields will vary. If all the phases are the same or similar, then all the GP fields add in-phase and create a strong GP. Conversely, if the phases of the GP fields are all different (e.g., random), then these fields add incoherently, and the resulting total GP has a relatively small amplitude. The inventor recognized that the generation of GPs depends on the relative phase of the logical “ones” which create the GPs via their overlap.

The Inventor created a method by which the phases can be modified so as to suppress the generation of the GPs. In one embodiment of the present invention, the phases of logical “ones” at the transmitter are altered such that the phases of the GP fields, generated by an individual triplet of “ones” in a long sequence like 1111101111, become “pseudo-randomized” and the sum of those GP fields is greatly reduced as compared to the case where no phase modulation is applied.

In a second embodiment of the present invention, phase modulation is applied at the middle of the transmission line. In the second embodiment of the present invention, the phases of the “ones” are altered in such a way that the phases of a GP filed created by each individual triplet of “ones” is changed by π (the sign of each GP field is inverted). As such, the growth of the ghost pulses is reversed and, at the end of the transmission line, their amplitude is nearly zero or, at least, greatly suppressed in comparison with the case where no phase modulation is implemented.

To alter the phase relation of the “one” pulses, one embodiment of the present invention uses a phase modulator (e.g., an electro-optic modulator). Additionally, the parameters of the sinusoidal RF phase-modulating signal, such as its period (relative to the bit rate) and the amplitude, are carefully adjusted in order to ensure a net improvement in the transmission properties. A signal with electric field u passing through such a modulator is changed according to the following formula:

u→u*exp[i*A*sin(2*π*t/Tmod+φ)], (1)

wherein A and Tmod are the amplitude and period of the phase modulation, respectively. The constant φ, which characterizes the phase of the RF phase-modulating signal (the exponent in Equation (1)), determines the timing of the phase modulating signal relative to the power profile of the optical signal. The Inventor has determined such values of A and Tmod that provide suppression of GPs for arbitrary values of φ. These values are specified below.

It should be noted that when phase modulation is applied to a sequence of pulses, chirp is induced into each pulse, and the chirp induced can be different for different pulses. Hence distortions of different pulses cannot be simultaneously compensated by post compensation in the transmission system. To minimize this effect, the period of the phase modulation is selected to be greater than the bit period of the system yet not too large, because the beneficial effect of the ghost pulse suppression technique may diminish or disappear.

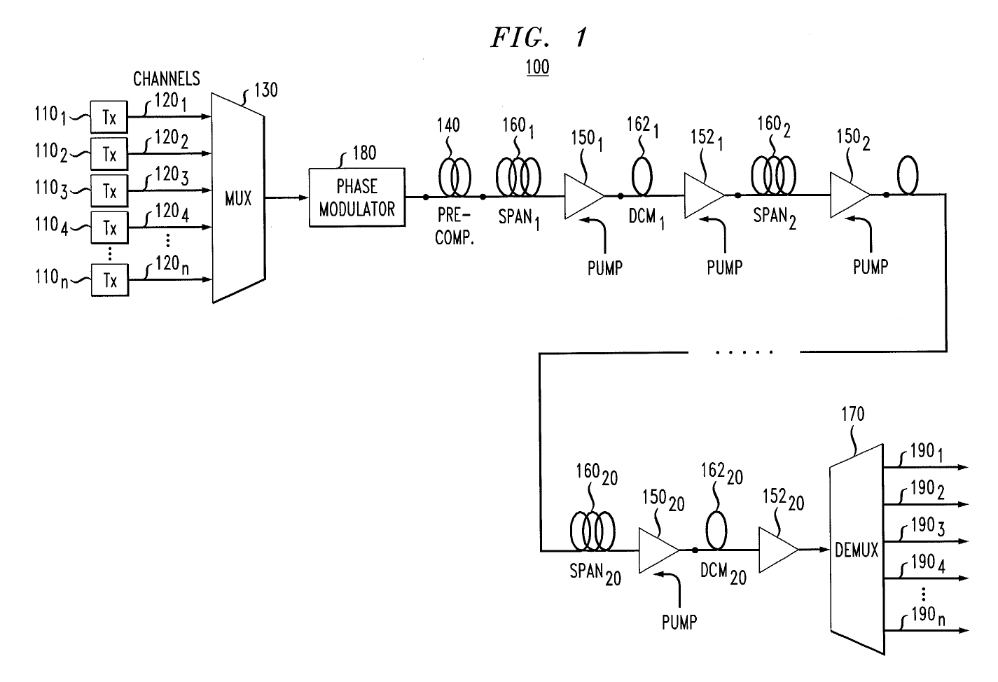

FIG. 1 depicts a high-level block diagram of a transmission system including a first embodiment of the present invention. The transmission system 100 of FIG. 1 includes a plurality of pulse transmitters 110₁-120ₙ (collectively pulse transmitters 110), a plurality of input channels 120₁-120ₙ (collectively input channels 120), a multiplexer 130, a pre-compensating fiber 140, two amplifiers per one cell of dispersion map (illustratively all-Raman backward-pumped amplifiers) 150 and 152, 20 spans of 80 km standard single-mode fiber (SSMF) 160, with each span followed by a dispersion-compensating module (DCM) 162 which provides path-average dispersion of 0.25 ps/nm/km at 1580 nm, a demultiplexer 170, and a plurality of output channels 190₁-190ₙ (collectively output channels 190). In addition, a phase modulator 180 is added to the transmission system 100 and located directly after the multiplexer 130. 66% carrier-suppressed return-to-zero (CSRZ) pulses are used as an input source to the transmission system 100. However, the same method will also work with 33% RZ pulses; the CSRZ pulses are used only to minimize the sensitivity of the pulses to inaccuracies of dispersion compensation. The input power of each channel is −2 dBm. The data extinction ratio of the input source is 12.5 dB. The multiplexer 130 and the demultiplexer 170 used are dispersionless 3^{rd} and 4^{th} order Gaussians with 85 GHz FWHM. The Raman pumps in the span provide 17 dB of gain, with the remaining gain provided by the pumps in the DCM 162. The amount of dispersion pre-compensation is optimized at −500 ps/nm.

In a transmission system such as the transmission system 100 of FIG. 1, there are at least two possible ways to apply phase modulation in accordance with the present invention. In one case, phase modulation can be created by the same pulse carver that creates the sequence of logical “ones” at the transmitter. In another case, phase modulation can be applied to the total signal consisting of several channels, after they have been combined by the multiplexer 110. The ability to vary the placement of the phase modulator is a direct consequence of the fact that the proposed method is functional for arbitrary values of the parameter φ in Equation (1). FIG. 1 depicts only the case wherein the phase modulator 180 is located after the multiplexer 130. It should be noted though, that locating the phase modulator after the multiplexer, although being potentially cheaper, has a drawback that is not present when applying phase modulation at each transmitter, prior to a multiplexer. Specifically, the electro-optic modulator is a polarization sensitive device and will modulate the two polarizations of an optical signal differently. To compensate for the polarization sensitivity of the electro-optic modulator, it is preferred to implement two modulators whose polarization states are aligned orthogonal to each other in order to not introduce polarization-related distortions to the signals.

Referring to FIG. 1, the amplitude A and period Tmod of the phase modulation required to suppress GPs in the transmission line described above was estimated. The dispersion of the SSMF at 1580 nm is about 18 ps/nm/km, or 23 ps²/km. As the full width at half maximum power of a 40-Gigabit CSRZ pulse after passing through a multiplexer is about 13 ps, the pulse broadening occurring after, typically, half of the span is approximately (23 ps²/km*40 km)/(13 ps*1.67)²˜16 times. Therefore, each pulse overlaps with approximately 16*13 ps/25 ps˜8 other pulses on each side. Thus, logical “ones” in a sequence including at most 8 consecutive “ones” on each side of a “zero” (e.g., 11111111011111111) will interfere coherently to create GP fields via IFWM at the location of the “zero”. Any longer sequence of “ones” will create the same total GP as the above sequence, because a pulse does not overlap with another pulse with more than 8 bits of separation, and hence such two pulses do not interact. It will be appreciated by those skilled in the art that the above numerical estimates for the length of the pulse sequence and amount of pulse broadening are specific to the pulse width of 13 ps and fiber dispersion of 18 ps/nm/km. Similar calculations can be performed for other pulse widths and fiber dispersions in accordance with the present invention.

In order to obtain initial estimates of the amplitude, A, and period, Tmod, of the phase modulation, the inventor wrote a simple and fast code which calculates a sum of the individual GP fields for an arbitrary data segment of the form: N “ones”, “zero, M “ones” (this is the pattern that creates a worst-case GP). For a given a value of A, the code takes less than 1 minute to produce a plot of the required sum as a function of Tmod and φ. An embodiment of the inventor's code is included at the end of the specification. Upon visual inspection of such a plot for a given value of A, such values of Tmod are found that for all values of φ, the total GP is most suppressed compared with the case of no phase modulation. In this manner, it is calculated that for the transmission system of FIG. 1 above, the optimum amplitude of phase modulation, A, is between 1.2 and 1.4, whereas the optimum value of the period of phase modulation, Tmod, is between 3 and 5 bit periods. These parameters are relatively rough estimates allowing the narrowing down of the parameter space. Direct numerical simulation of transmission is required to verify that phase modulation with those parameters indeed leads to efficient suppression of GPs.

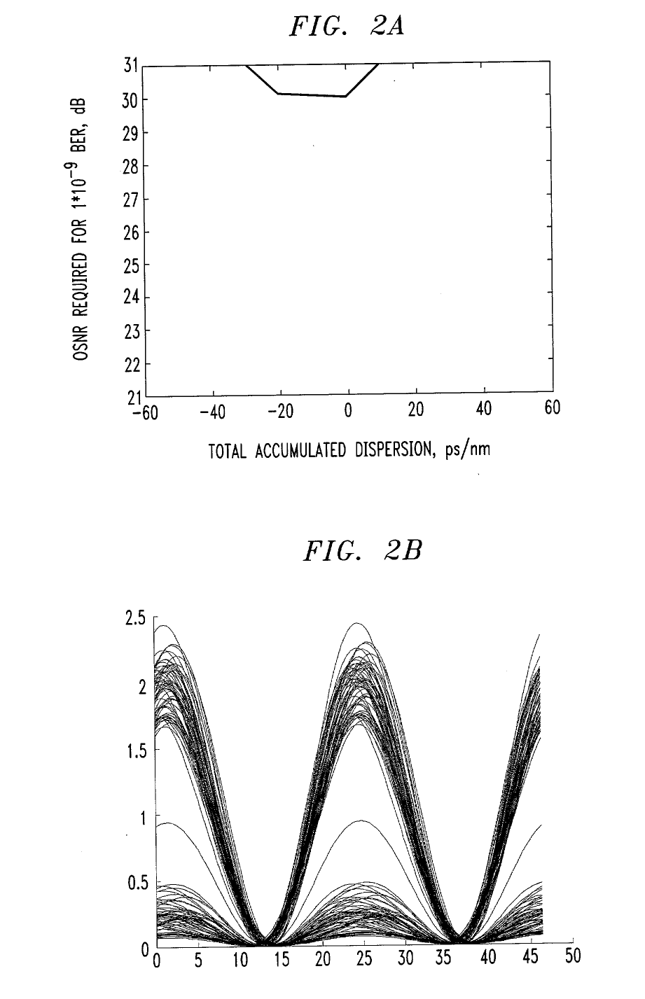

FIG. 2a graphically depicts the optical signal-to-noise ratio (OSNR) in 0.1 nm required for a bit error rate (BER) of 10⁻⁹ in the transmission system 100 of FIG. 1 for the case of no phase modulation. The optical OSNR of FIG. 2a is depicted as a function of total accumulated dispersion in the transmission line. The OSNR required for a above BER of of 10⁻⁹ before transmission is ˜23 dB. Thus, as evident from FIG. 2a, the transmission penalty of the transmission system 100 of FIG. 1 without phase modulation is 7 dB. These results were obtained at the optimum value of post-compensation.

FIG. 2b graphically depicts the corresponding optical eye diagram for the section of the bit sequence depicted in FIG. 2a. A large GP is evident in FIG. 2b.

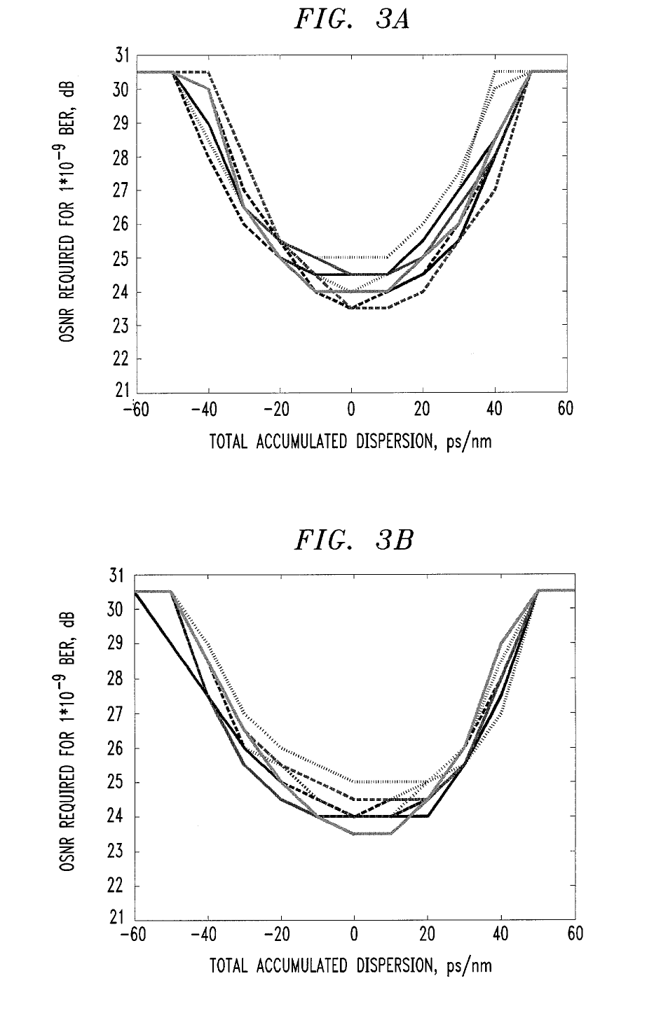

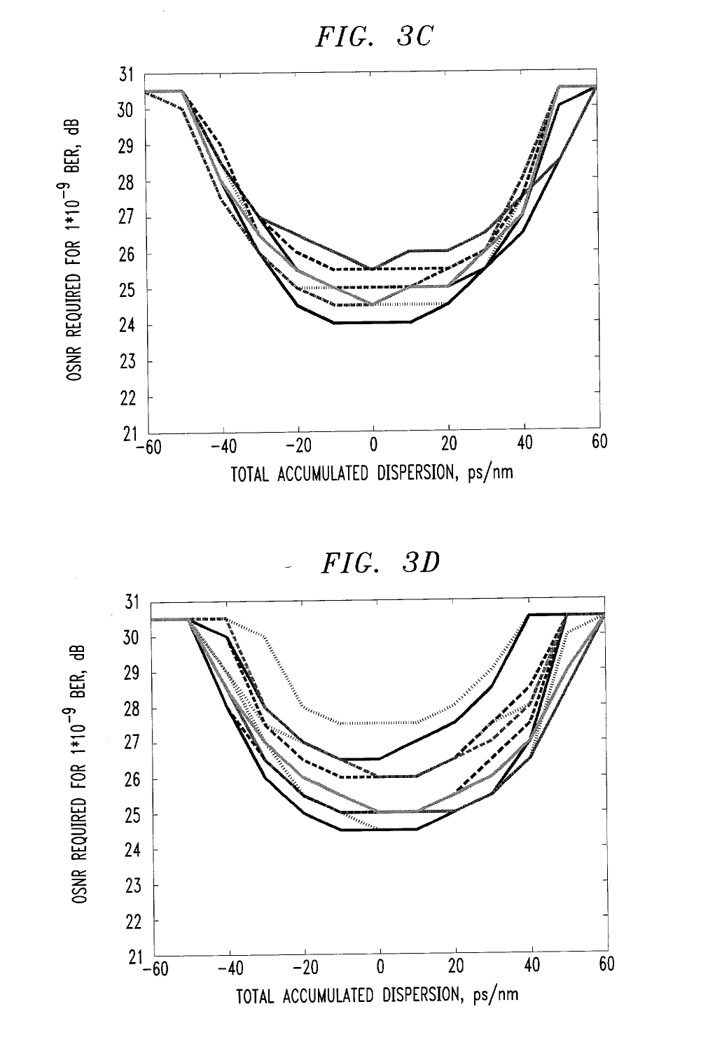

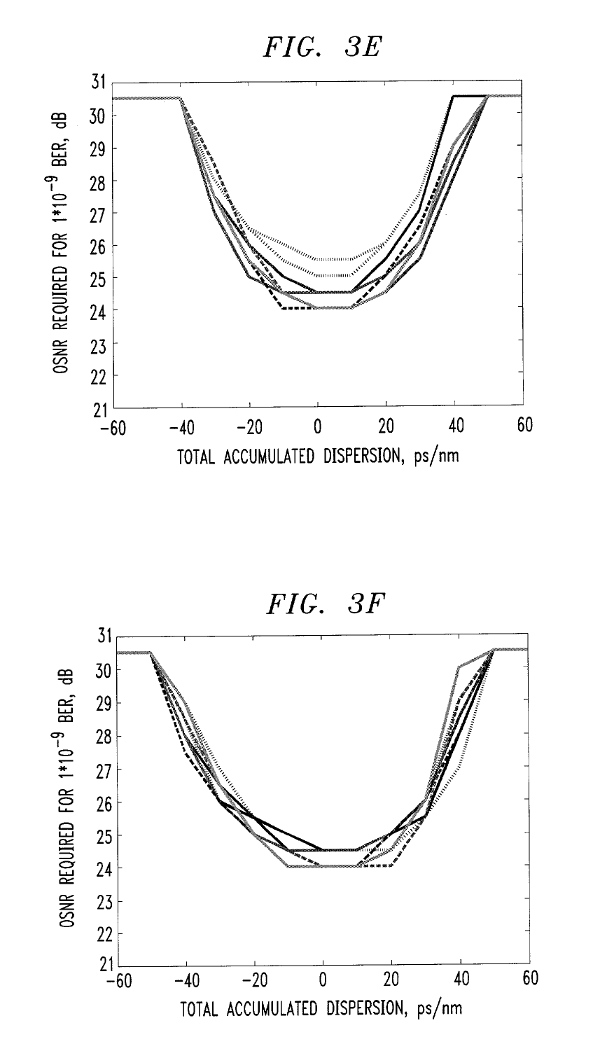

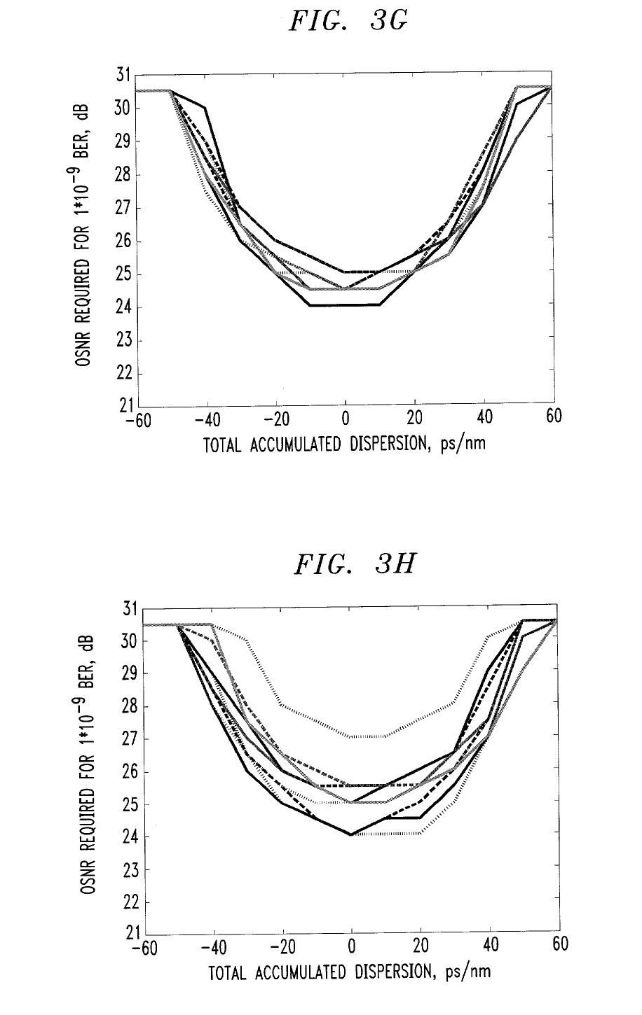

FIGS. 3a though 3d graphically depict the required OSNR for a BER of 10⁻⁹ for the transmission system of FIG. 1, wherein the phase modulation has an amplitude A=1.2 and modulation periods Tmod=2.5, 2.9, 3.3, 4.0 bit periods, respectively. FIGS. 3e though 3h graphically depict the required OSNR for a BER of 10⁻⁹ for the transmission system of FIG. 1, wherein the phase modulation has an amplitude A=1.4 and modulation periods Tmod=2.5, 2.9, 3.3, 4.0 bit periods, respectively. The different lines in each plot correspond to different values of φ, varying from 0.1 π to 1.9 π with steps of 0.2 π%. It is evident from these plots that phase modulation with amplitudes between 1.2 and 1.4 and periods between 2.5 and 3.3 of the bit period, efficiently suppress ghost pulses, thus resulting in transmission penalties of only 2 to 3 dB. This reflects a 4 to 5 dB improvement in the transmission penalty of the transmission system 100 in the case of no phase modulation.

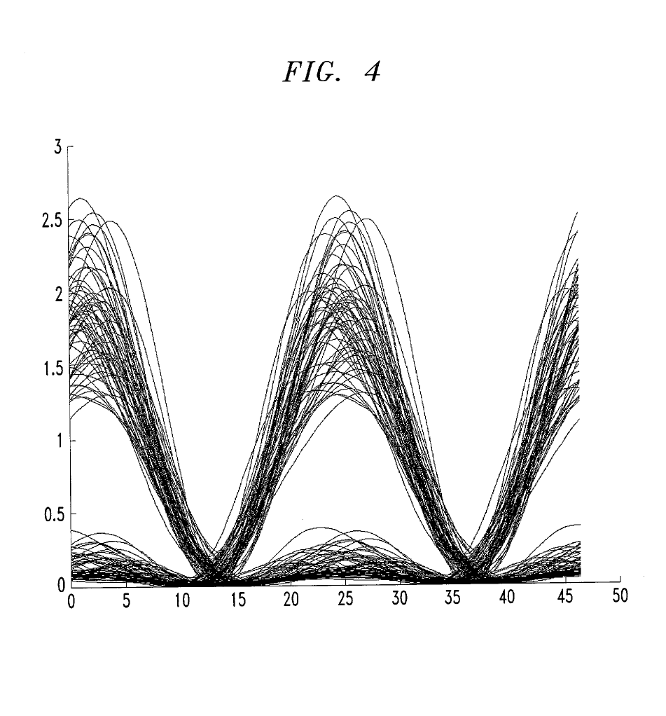

FIG. 4 graphically depicts an optical eye diagram for an optical signal at the output of the transmission system 100 for the following parameters of phase modulation: A=1.4, Tmod=3.3 bit periods, and φ=1.5 π, which reflects the worst-case scenario depicted in FIG. 3g. Suppression of the worst GP is evident from the comparison of FIG. 4 with FIG. 2b.

It was also verified that when the amplitude of phase modulation is increased to A=1.6, the range of the values of the phase modulation period decrease to between 2.8 and 3.3 bit periods. When A=1.8, the transmission penalty increases from 2-3 dB to 4 dB and above for any period of phase modulation. Conversely, when the amplitude A is not large enough (e.g., A=1.0), the transmission penalty, again, exceeds 4 dB. Thus, the amplitude and period of phase modulation need to be chosen carefully, as described above, to ensure good transmission performance for arbitrary values of the parameter φ.

The same method can also be applied to obtain parameters of phase modulation which are required to suppress generation of GPs in NZ-DSF, such as TWRS™ fiber. In the description presented below, the focus is on the main difference between transmission in a NZ-DSF fiber and transmission in the SSMF considered earlier. Specifically, the dispersion of NZ-DSF at 1580 nm is about 3 times less than dispersion of the SSMF, and hence pulse broadening is also 3 times less in the NZ-DSF. Consequently, a pulse will overlap with at most 3 neighbors on each side, and therefore a sequence 1110111 will generate as large a GP as a sequence 1111111011111 (e.g. with more than 3 “ones” on each side of the “zero”). As in the case of SSMF transmission fiber, the sum of the GP fields created by individual triplets of logical “ones” is calculated. The suppression of the generation of GPs by such short sequences requires the amplitude of the phase modulation to be between 1.2 and 1.4 and its period, between 3.3 and 4 bit periods. This conclusion is verified by direct numerical simulations of such transmissions.

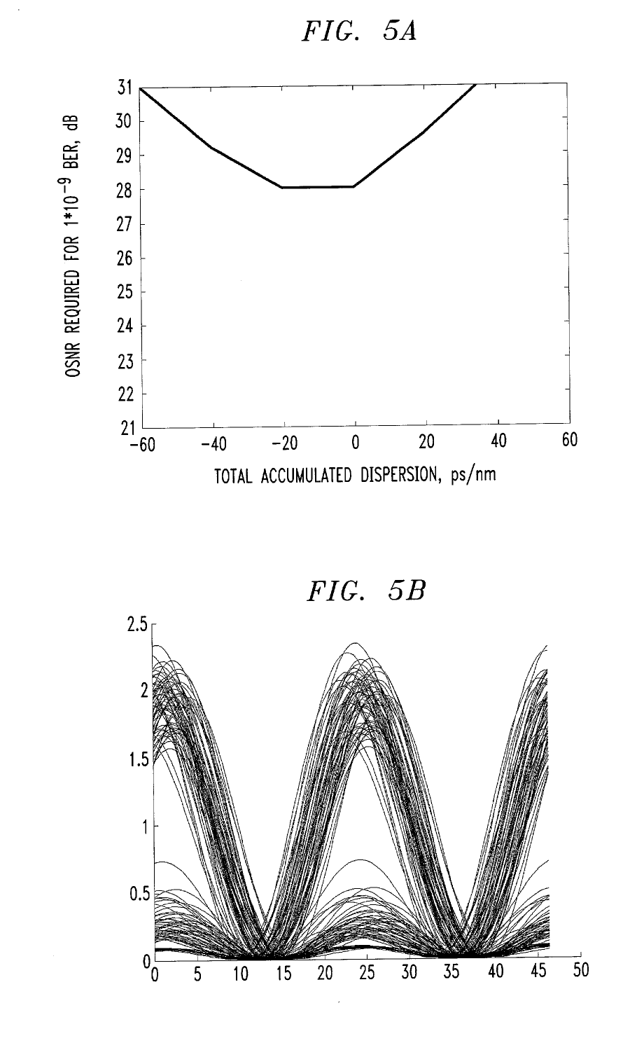

FIG. 5a graphically depicts the OSNR required for a BER of 10⁻⁹ for 16 spans of 100 km of TWRS™, with path-average dispersion of 0.15 ps/nm/km, pre-compensation of −160 ps/nm/km, and no phase modulation. The remaining parameters are similar to those reported for the SSMF simulations. As noted in the case of the SSMF transmission fiber, the required OSNR back-to-back is 23 dB. As such, as evident from FIG. 5a, the transmission penalty without phase modulation in this case is 5 dB.

FIG. 5b graphically depicts the corresponding optical eye diagram for the section of the bit sequence depicted in FIG. 5a for the case of optimal dispersion post-compensation. Several large GPs are evident in FIG. 5b.

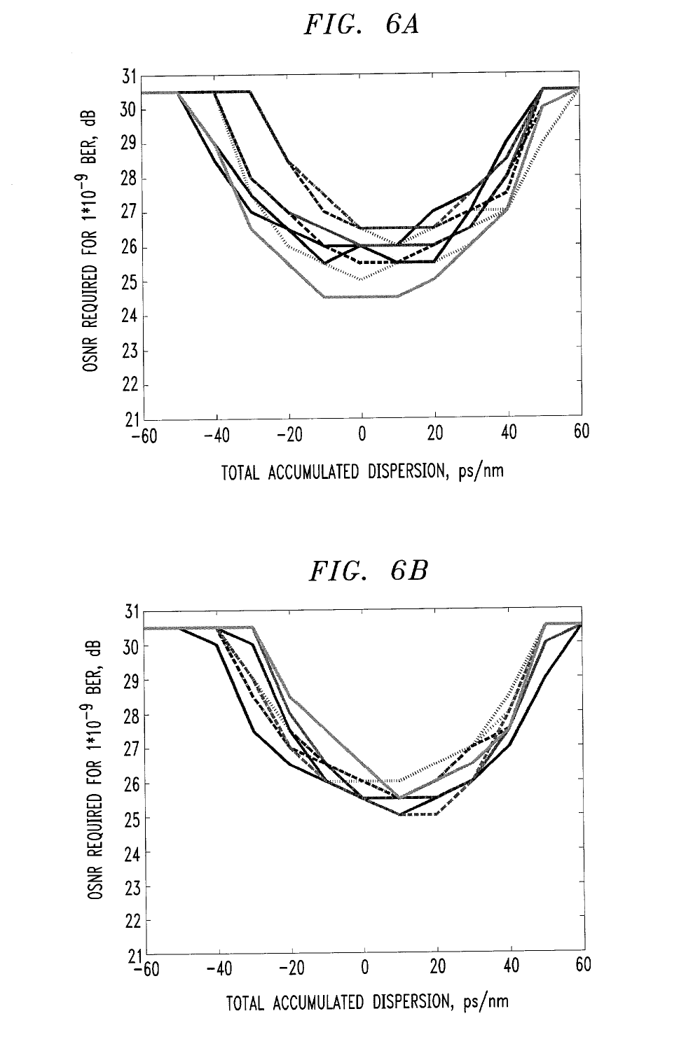

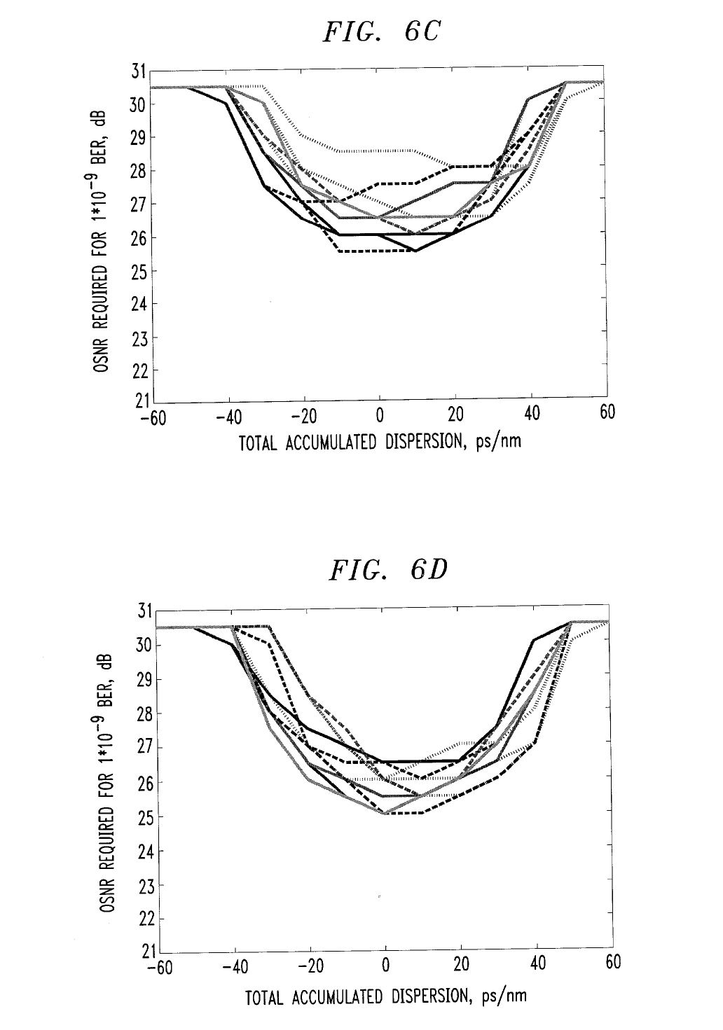

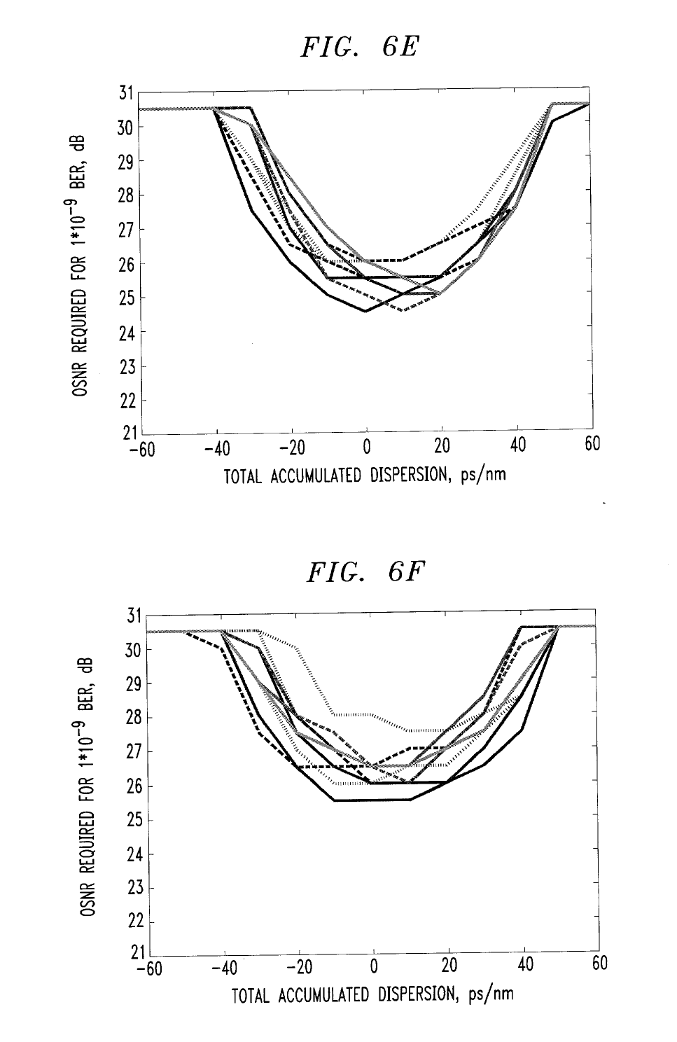

FIGS. 6a through 6c graphically depict the required OSNR for a BER of 10⁻⁹ for the transmission system of FIG. 5a, wherein the phase modulation has an amplitude A=1.2 and modulation periods equal to 3.0, 3.3, and 3.7 bit periods, respectively. FIGS. 6d through 6f graphically depict the required OSNR for a BER of 10⁻⁹ for the phase modulation amplitude A=1.4 and modulation periods equal to 3.0, 3.3, and 3.7 bit periods, respectively. Different lines in each plot correspond to different values of φ, as explained earlier for the SSMF case.

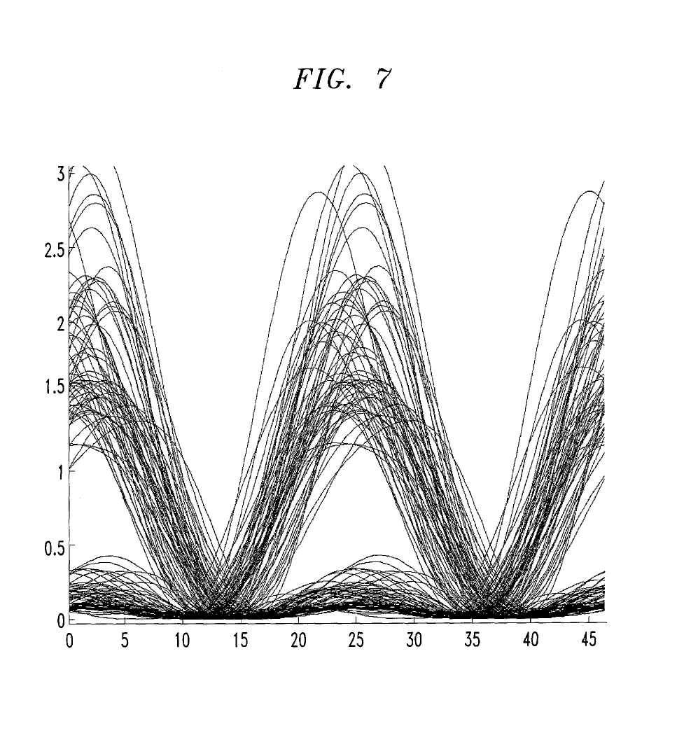

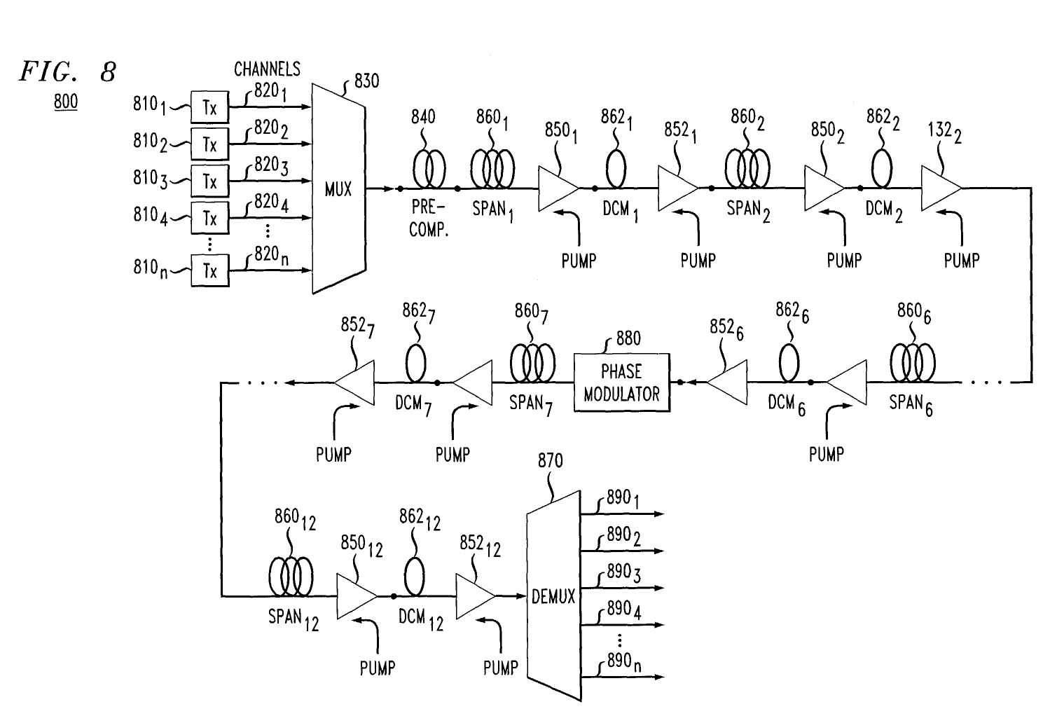

FIG. 7 graphically depicts an optical eye diagram for a section of the bit sequence in the transmission system of FIG. 5a, wherein the phase modulation has an amplitude A=1.3, and a period Tmod=3.3 bit periods, and a parameter φ=1.5 π. Suppression of GPs is evident from the comparison of FIG. 5b with FIG. 7. However, in contrast to case of SSMF transmission fiber, the range of values of the period of the phase modulation required in TWRS™ is much narrower: only between 3.0 and 3.3 of the bit period.

FIG. 8 depicts a high-level block diagram of a transmission system including a second embodiment of the present invention. The transmission system 800 of FIG. 8 includes a plurality of pulse transmitters 810₁-810ₙ (collectively pulse transmitters 810), a plurality of input channels 820₁-820ₙ (collectively input channels 820), a multiplexer 830, a pre-compensating fiber 840, two amplifiers per one cell of dispersion map (illustratively all-Raman backward-pumped amplifiers) 850 and 852, 12 spans of 100 km SSMF 860, with each span followed by a dispersion-compensating module (DCM) 862₁-862₁₂ which provide path-average dispersion of 0.32 ps/nm/km at 1580 nm, a demultiplexer 870, and a plurality of output channels 890₁-890ₙ (collectively output channels 890). In addition, a phase modulator 880 is added to the transmission system 800 and located substantially in the middle of the transmission system 800 in accordance with the present invention.

The main difference between the transmission system 800 of FIG. 8 and the transmission system 100 of FIG. 1 is the placement of the phase modulator at the midpoint of the transmission line in the transmission system 800 of FIG. 8. It should be noted that using two modulators with orthogonally-polarized outputs is appropriate in this embodiment of the invention, for the reason explained above for the alternate embodiment wherein the phase modulator was placed after the multiplexer. In the transmission system 800 of FIG. 8, 66% CSRZ pulses are used as an input source to the transmission line 800. However, the same method will also work with 33% RZ pulses; the CSRZ pulses are used only to minimize the sensitivity of the pulses to inaccuracies of dispersion compensation. The input power of each channel is 0 dBm. The data extinction ratio of the input source is 12.5 dB. The multiplexer 830 and the demultiplexer 870 used are dispersionless 3^{rd} and 4^{th} order Gaussians with 85 GHz FWHM. The Raman pumps in the span provide 21 dB of gain, with the remaining gain provided by the pumps in the DCM. The amount of dispersion pre-compensation is optimized at −400 ps/nm. Modifications to these operating parameters will be appreciated by those skilled in the art.

In a numerical experiment performed by the Inventor, phase modulation was applied after the 6^{th} span of the transmission line 800 of FIG. 8. To be cost effective, in a transmission system with multiple channels, phase modulation must be applied to all channels at once rather than on a per-channel basis. To accomplish simultaneous phase modulation which causes minimal collateral distortion of the signals, the pulses in all the channels must be substantially transform limited (not spread by dispersion) at the point where phase modulation is applied. For example, if phase modulation is applied after the Nth span of a transmission line, by that point, a particular channel has experienced a total dispersion accumulation equal to the sum of the dispersion pre-compensation and the residual dispersion per span times N, the number of spans:

D_{accum}=Dₚᵣₑ+Dᵣₑₛ*N. (2)

As such, a dispersion compensating module (DCM) should be chosen for the Nth span to provide an amount of dispersion equal to and opposite in sign to D_{accum}. Additionally, a dispersion-curvature correction device, such as a grating, may be required, because commercial DCMs, available as of the time of this writing, may not be able to provide total dispersion compensation for all channels across a wideband.

Referring to the numerical experiment performed on the transmission line 800 of FIG. 8, the length of the 6^{th} span in the transmission line is set to 112 km, while DCM100s are used in all of the 6 initial spans. With this arrangement, pulses in all the channels accumulate less than or about +20 ps/nm at the point following the 6^{th} DCM, where phase modulation is applied, and thus are substantially transform limited (accumulated dispersion of nearly zero). At the 7th span, a 100 km SSMF and a DCM112 are implemented to bring the average dispersion, D_{avg}, back to its value prior to the compensation and phase modulation.

The signal at the end of the transmission line was then analyzed. The optimum values for the phase modulation amplitude, A, and period, Tmod, were again calculated as described above, except that, in this case, the values of A and Tmod were calculated such that the sum of GP fields from individual triplets of “ones” in a sequence of the form N “ones”, “zero”, M “ones, substantially reverses its sign, compared to the case with no phase modulation, for all possible values of the parameter φ defined in Equation (1). Since reversal of the sign of a quantity is equivalent to a change of its complex phase by π, then it is the phase of the sum which is monitored while finding the optimum values of A and Tmod. It was discovered that this phase is closest to π, for all values of φ, when A is between 1.5 and 1.6 and Tmod is between 4.5 and 5.0 bit periods. When A is less than 1.5, only incomplete sign reversal of the sum of GP fields is attained. On the other hand, when A is substantially larger than 1.6, the phase of the sum becomes strongly dependent on φ and cannot be made to be substantially π for all values of φ. As before, the above values of A and Tmod are only quick estimates, and direct numerical simulations of the transmission are required to guarantee that these or similar values in fact result in suppression of ghost pulses and reduction of the transmission penalty. Such results are described herein.

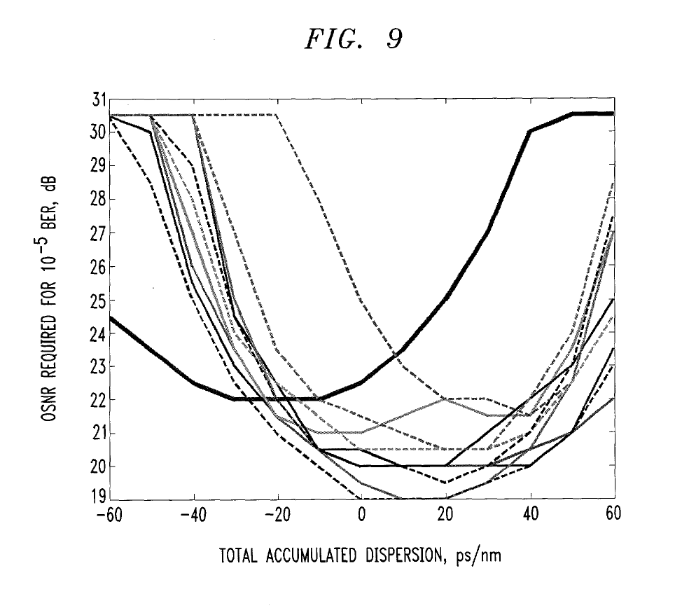

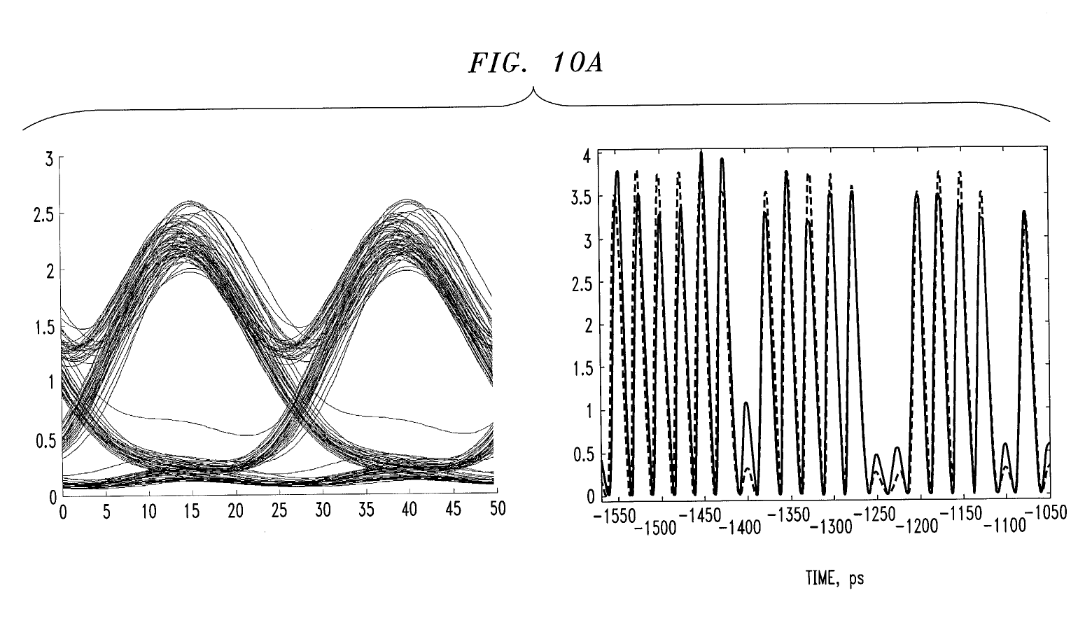

FIG. 9 graphically depicts the OSNR required for a BER of 10⁻⁵ in the transmission system of FIG. 8 for the case of no phase modulation, and for the cases wherein the phase modulation has an amplitude A=1.5, a period Tmod=4.5 bit periods, and a parameter φ varying between 0.1 π to 1.9 π with a step of 0.2 π. (A value of 10⁻⁵ for the BER is illustrated because in an actual transmission system (not in a testbed), the OSNR will be sufficiently low due to many possible degradation sources and the transmission system will only be able to provide a BER of that order of magnitude. As such, forward error correction, such as post compensation, will be used to increase the BER of the transmission system to the required value of 10⁻¹⁶ for high bit-rate transmission systems.) The thick line in FIG. 9 represents the performance of the transmission system 800 without phase modulation, and the other lines represent the performance of the transmission system 800 for A=1.5 and Tmod=4.5 of the bit rate. The different lines correspond to different values of φ, as explained earlier for the first embodiment of the invention. As depicted in FIG. 9, when the phase modulation is applied to the transmission system the required OSNR for a BER of 10⁻⁵ is 0 to 3 dB lower than in the case with no phase modulation.

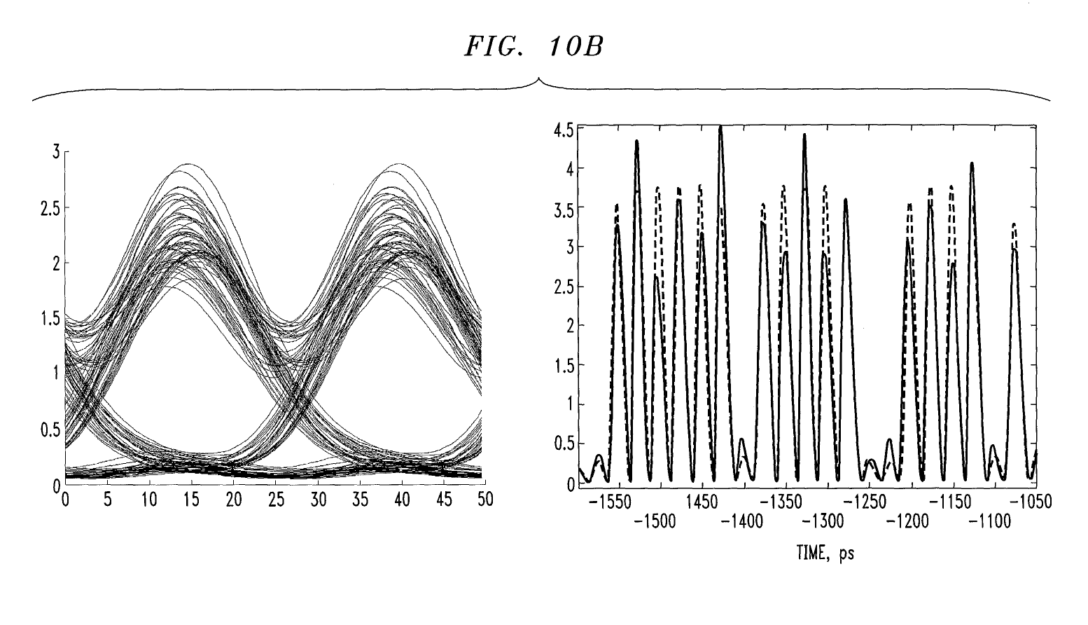

FIG. 10a graphically depicts an electrical eye diagram and an optical waveform diagram for the section of the bit sequence depicted in FIG. 9 with no phase modulation. FIG. 10b graphically depicts an electrical eye diagram and an optical waveform diagram for the section of the bit sequence depicted in FIG. 9 for the case of phase modulation applied after the 6^{th} span. In comparing the waveforms of FIG. 10a and FIG. 10b, it is evident that when phase modulation is applied in accordance with the present invention, the ghost pulses produced by the transmission system 800 are significantly reduced. The reduction in the ghost pulses can lead to a reduction in BER and thus to an improvement of transmission quality.

It will be appreciated by those skilled in the art that other embodiments of the present invention, wherein different amounts of phase modulation and varied locations for the application of the phase modulation, can be advantageously implemented to reduce ghost pulses in transmission systems in accordance with the present invention. Furthermore, varied values of pre-compensation and post compensation can be employed within the concepts of the present invention to ensure net improvement in the transmission properties of a signal in a transmission system.

While the forgoing is directed to various embodiments of the present invention, other and further embodiments of the invention may be devised without departing from the basic scope thereof. As such, the appropriate scope of the invention is to be determined according to the claims, which follow.

% This program sums phasors of certain combination of
pulses.
% The goal is to find a minimum or a maximum of a certain
combination,
% in order to minimize IFWM in 40-G transmission.

| | |
|---|---|
| N_left=5; | % # of 1's on the left of the |
| potential ghost pulse | |
| N_right=6; | % # of 1's on the right of the |
| potential ghost pulse | |
| phi = [0 : pi/49 : pi] ; | % arbitrary initial phase of |

the additional phase modulation

| | |
|---|---|
| x = [0 : 2*pi/99 : 2*pi] ; | % 2*pi/T_mod*T_bit, where T_mod |
| is the modulation period | |

A=input ( ′ enter overall multiple of all phases, A = ′) ;

% overall multiple of all

phases
% Set up phases of left and right 1's:
for n_phi=1 : length (phi)

for n_x=1 : length (x)

for n_left=1 : N_left

psi_left (n_phi,n_x,n_left) =A*sin (phi (n_phi) +n_left*x (n_x) ) ;

end
for n_right=1 : N_right

psi_right (n_phi,n_x,n_right) =A*sin (phi (n_phi) -

n_right*x (n_x) ) ;

end

end

end
% Set up phasors coming from left-left, right-left, left-
right, and right-left combinations of 1's.
% Left-left contributions:
phasor_LL=zeros (size (psi_left ( : ,: , 1 ) ) ) ;
for k=1 : N_left - 1

for m=1 : N_left - k

phasor_LL=phasor_LL+exp (i* (psi_left ( : ,: , k ) +psi_left ( : ,: , m) -
psi_left ( : , : , m+k ) ) ) ;

end

end

| | |
|---|---|
| phasor_LL=phasor_LL/2; | % divide by 2 since we have |

counted contribution from the pair (k,m) = (m,k) twice
% Right-right contributions:
phasor_RR=zeros (size (psi_right ( : , : , 1 ) ) )
for k=1 : N_right - 1

for m=1 : N_right - k

phasor_RR=phasor_RR+exp (i* (psi_right (:,:,k) +psi_right (:,:,m
) -psi_right ( : , : , m+k ) ) ) ;

end

end

| | |
|---|---|
| phasor_RR=phasor_RR/2; | % divide by 2 since we have |

counted contribution from the pair (k,m) = (m,k) twice
% 2 - Left - 1 - right contributions:
phasor_2L1R=zeros (size (psi_left ( : , : , 1 ) ) ) ;
for k=1 : N_left - 1

for m=1 : min (N_right,N_left - k)

phasor_2L1R=phasor_2L1R+exp (i* (-

psi_left ( : , : , k ) +psi_right ( : , : , m ) +psi_left (:,:,m+k) ) ) ;

end

end

| | |
|---|---|
| phasor_2L1R=phasor_2L1R; | % do NOT divide by 2 since we |

count contribution from the pair (k,m) only once
% 1 - Left - 2 - right contributions:
phasor_1L2R=zeros (size (psi_left ( : , : , 1 ) ) ) ;
for k=1 : N_right - 1

for m=1 : min (N_left,N_right - k)

phasor_1L2R=phasor_L2R+exp (i* (-

psi_right (:,:,k) +psi_left ( : , : , m ) +psi_right ( : , : , m+k ) ) ) ;

end

end

| | |
|---|---|
| phasor_1L2R=phasor_1L2R; | % do NOT divide by 2 since we |

count contribution from the pair (k,m) only once
total_phasor=phasor_LL+phasor_RR+phasor_2L1R+phasor_1L2R;
figure (1) ;
waterfall (abs (total_phasor) )
% % Calculate a quantity proportional to the difference of
central frequencies of the 2 pulses:
%
% for n_phi=1 : length (phi)
% freq_diff (n_phi, : ) =x. * (cos (x+phi (n _phi ) ) -
cos (phi (n_phi) ) ) ;
% end
% figure (2) ;
% waterfall (freq_diff)
%
% % Calculate qantity proportional to the chirp of each
pulse:
%
% for n_phi=1 : length (phi)
% chirp (n_phi, : ) = (x.\hat{ }2) .* (sin (x+phi (n_phi ) ) -
sin (phi (n_phi) ) ) ;
% end
% fiqure (3) ;
% waterfall (chirp)

What is claimed is:

1. A method for reducing transmission penalties associated with ghost pulses in an optical signal in an optical transmission system, comprising:
applying phase modulation to the optical signal to modify the phases of all of the logical “ones” of the optical signal, such that the phases of each individual ghost-pulse field created by an individual sequence of “ones” become substantially different, and the resulting total ghost pulse, which is a sum of the individual ghost-pulse fields, is reduced compared to the case where no phase modulation is applied.

2. The method of claim 1, wherein the timing of the phase modulation is not synchronized with the timing of a power profile of the optical signal.

3. The method of claim 1, wherein said optical transmission system is a WDM transmission system and said phase modulation is applied at a transmitter in each input channel of the WDM transmission system prior to combining the input channels.

4. The method of claim 1, wherein said phase modulation is applied using at least one phase modulator per transmitter.

5. The method of claim 1, wherein said optical transmission system is a WDM transmission system and said phase modulation is applied to all channels simultaneously, after said all channels are combined by a multiplexer.

6. The method of claim 1, wherein said phase modulation is applied to the optical signal in said optical transmission system with a period of phase modulation greater than a bit period of the optical transmission system.

7. The method of claim 1, wherein said phase modulation is applied to the optical signal near the midpoint of the optical transmission system, and wherein the phases of all of the logical “ones” of the optical signal are modified such that the phases of each individual resulting ghost-pulse field is substantially shifted by π.

8. A method for reducing transmission penalties associated with ghost pulses in an optical signal in an optical transmission system, comprising:
modulating the phase of the optical signal pulses having a first state, such that resulting ghost pulse fields created by successive first state sequences are not identical.

9. The method of claim 8, wherein said first state of the optical signal pulses represents a logical one.

10. The method of claim 9, wherein said successive first state sequences represent successive logical one triplets.

11. The method of claim 9, wherein a reduction of a total ghost pulse is achieved by modulating the phases of at least some of the logical “ones” in a sequence of logical “ones”, such that the phases of resulting ghost pulse fields are substantially random, thus adding incoherently and resulting in said total ghost pulse having a relatively small amplitude.

12. The method of claim 8, further comprising:
pre-compensating the optical signal at the point of said modulating to cause the optical signal to be substantially transform-limited.

13. The method of claim 12, further comprising:
post-compensating the optical signal after said pre-compensating to return the optical signal to the value of dispersion prior to said modulating.

14. The method of claim 8, wherein said optical transmission system is a WDM transmission system and said phase modulation is applied at each input channel of the WDM transmission system prior to combining said each input channel.

15. The method of claim 8, wherein said optical transmission system is a WDM transmission system and said phase modulation is applied to all channels simultaneously, immediately after said all channels are combined

16. The method of claim 8, wherein said phase modulation is provided using at least one phase modulator.

17. The method of claim 8, wherein said phase modulation is provided using two phase modulators.

18. The method of claim 17, wherein the output polarizations of the two phase modulators are aligned orthogonal to each other.

19. The method of claim 8, wherein said phase modulation is applied to the optical signal pulses in said optical transmission system with a period of phase modulation greater than a bit period of said optical transmission system.

20. An improved optical transmission system, the improvement comprising:
at least one phase modulator, for providing phase modulation to an optical signal to modify the phases of all of the logical “ones” of the optical signal, such that the phases of each individual ghost-pulse field created by an individual triplet of “ones” become substantially different, and the resulting total ghost pulse, which is a sum of the individual ghost-pulse fields, is reduced compared to the case where no phase modulation is applied.
